(19) United States
(12) Patent Application Publication
(10) Pub. No.: US 2018/0165649 A1
(43) Pub. Date: Jun. 14, 2018

(54) System and Method for Control of Transport Processes

(71) Applicant: Audi AG, Ingolstadt (DE)

(72) Inventors: Martin Quitzke, Ingolstadt (DE); Robert Ali, Ingolstadt (DE); Felix Schroeder, Munich (DE); Jan Glaser, Ingolstadt (DE); Patrick Heinemann, Kösching (DE); Christian Wrusch, Ingolstadt (DE)

(73) Assignee: Audi AG, Ingolstadt (DE)

(21) Appl. No.: 15/839,069

(22) Filed: Dec. 12, 2017

(30) Foreign Application Priority Data
Dec. 13, 2016 (DE) 102016224768.9

(51) Int. Cl. G06Q 10/10; G07B 15/02; G06Q 50/30; G06Q 10/06

(52) U.S. Cl. CPC G06Q 10/109; G07B 15/02; G06Q 2240/00; G06Q 10/06311; G06Q 50/30

(57) ABSTRACT

Disclosed are embodiments for systems and methods for controlling transport processes. Certain embodiments synchronize, for a given number of transport processes, which have to be executed within a predetermined time window, time windows of availability of vehicles and availability of drivers, in order to optimize the execution of the transport processes.

### TECHNICAL FIELD

The present invention refers to a system and method for controlling transport processes. The invention synchronizes, for a given number of transport processes, which have to be performed within a predetermined time window, time windows of availability of vehicles and availability of drivers, in order to optimize the execution of the transport processes.

### BACKGROUND

The execution of transport processes on demand, for transporting people or materials, may be performed with own vehicles and drivers. Moreover, transport companies, taxi or courier services are known, in which a company provides the transporting by using its own fleet of vehicles and employed drivers. Recently, in particular in the USA, mediation services for transportation services (such as Uber, Lyft) have entered the market, which provide drivers who are private citizens using their own cars. The transportation may also be performed with rented cars or with car sharing vehicles. While rented vehicles are usually property of a car rental company or a car sharing service, recently, in the USA, platforms have been created, which mediate rented vehicles of private owners (such as RelayRides, FlightCar, Getaround). In order to handle the transport processes, nowadays web-based software solutions are usually applied, in particular for variants, in which more than two parties are involved.

DE 10 2011 082 982 A1 discloses a method and a system for computer-based management of the usage of vehicles, which respectively comprise a telematics unit for transmitting predetermined data to a computer system and which comprise a keyless access and starting system. The method allows performing a car sharing in communities organized and managed by the owner of a vehicle. To this end, it is not necessary to use vehicles of a car sharing organization, but instead private vehicles, which are provided with a telematics unit and a keyless access and starting system.

### BRIEF DESCRIPTION OF DRAWINGS/FIGURES

The invention is schematically represented in the drawing by means of an embodiment and is explained with reference to the same drawing.

FIG. 1 schematically shows an example of an embodiment of the inventive system.

### DETAILED DESCRIPTION

In view of this background, an object of the present invention is to provide a system and a method through which transport processes might be controlled, in which at least three external parties are involved in its execution, i.e., a customer requiring the transport process, an accredited vehicle driver and an owner of a vehicle.

The term “external” in this context means that neither the customer nor the accredited vehicle driver are employed for operating the system, and the operator of the system is not the owner of the vehicle. The operator of the system is only active as an intermediary and coordinator between the external parties and regulates for example the exchange of information and payments between the external parties.

The term “accredited” as used in this context means that the vehicle driver, in order to be admitted to the system, has to prove his or her qualification for performing transport processes, such as by submitting documents such as driver's license, identification documents, certificates (such as for a secure driving training), presentation interviews (personally, by phone, by Skype, etc.). Further aspects such as age, language knowledge, nationality, working hours or similar may also be acquired. After the accreditation, the vehicle driver receives the status of “reliable driver.” In this way it is ensured that the customer of the transport order and the owner of the vehicle used for the transport process may count on the fact that this transport is performed by a qualified and reliable person.

An advantage of the inventive system is that the interaction of three external parties is facilitated: one vehicle owner, whose object is to earn money from her vehicle during times in which she doesn't need the vehicle for driving; an accredited vehicle driver or a company employing accredited vehicle drivers, such as a taxi company or a courier company; and a customer, who requires a transport service. All three parties thus achieve advantages: the vehicle owner may obtain additional income, the accredited vehicle driver or the company employing the same do not require their own vehicle fleet, and the customer receives a first-class service at an acceptable price.

The object of the invention is a system for controlling transport processes, comprising

a) a first client, which is adapted for receiving and detecting data of a transport process to be performed, comprising at least the identification of the transport process, the type of transport process, the starting point and destination point of the transport process and a time interval, during which the transport process has to be performed or must be performed, for forwarding data of the transport process to a server and for receiving data from the server;

b) a second client, which is adapted for receiving and detecting data of a vehicle driver, comprising at least the identification of the vehicle driver and at least a time interval, during which the vehicle driver is available for a transport process, for forwarding the data of the vehicle driver to a server and for receiving data from the server;

c) a third client, adapted for receiving and detecting data of a vehicle, comprising at least the identification of the vehicle, the position of the vehicle and at least a time interval, in which the vehicle is available for a transport process, for forwarding data of the vehicle to a server and for receiving data from the server;

d) a server, which is adapted for receiving data of the first, second and third client, for storing the received data, for processing and verifying the compatibility of data of the transport process to be performed, of the vehicle driver and of the vehicle, in particular for determining matches between the stored and detected time intervals for vehicle availability, vehicle driver availability and transport processes to be performed, for automatic associating a vehicle and a vehicle driver to a transport process to be performed based on the compatibility check, and for sending data comprising the time interval, in which the transport process has to be performed and the associated vehicle driver to the first client, for sending data comprising the time interval, in which the transport process has to be performed, the type of transport process, as well as the starting point and the destination point of the transport process and the associated vehicle and its location to the second client, and for sending data comprising the associated vehicle and the associated vehicle driver to the third client.

In the context of the present disclosure, a compatibility check is intended as checking the compatibility between the data of the vehicle, of the vehicle driver and of the customer or the transport process to be performed, i.e., whether the respective location and availability of the driver and of the vehicle may match or may be caused to match the requirements of the transport process to be performed.

In an embodiment of the system, the second client is adapted for returning to the server data comprising the confirmation or rejection of the transport process to be performed, after receiving from the server data comprising the time interval, in which a transport process has to be performed, the type of transport process, as well as the starting and destination points of the transport process and the vehicle associated to the transport process and its location.

In a further embodiment of the system, the second client is adapted for sending data regarding the execution of the transport process to the server after the execution of the transport process.

In an embodiment of the system, the server is adapted for sending data regarding the execution of the transport process to the third client after the execution of the transport process.

In a further embodiment of the system, the server is adapted for sending data regarding the execution of the transport process to the first client, after the execution of the transport process.

In an embodiment of the system, at least one of the clients is provided as a mobile application (app) or website. In an embodiment, all three clients are apps or websites, i.e., the user interface to all three external parties is provided by a mobile app or a website, which brings the parties together and determines correspondences between the time windows of availability of a private vehicle, of availability of an accredited vehicle driver, and a private or commercial transport order. The mobile application may be executed on any mobile device or mobile operating system configured for executing application software. Alternatively it may be envisaged to execute the application as a web application, wherein the inputs are provided through a local client computer of the user and the effective data processing and evaluation is essentially performed on a remote web server, wherein the result of the data processing is transmitted to the local client computer for displaying or printing. For each of the three parties an individualized application interface (API) is provided to facilitate system management and increase user comfort.

When information is input through one of the three clients (frontends), this information is forwarded to the server (backend), where an algorithm determines all available matches. These are transferred to the second client and displayed to the accredited driver through an interface (app or website) for selection. The confirmation or rejection of the order is transmitted back through the second client to the server. The data for the transport order and the availability of the vehicle are independently processed by the server. To this end, no further input is required through the first or third client.

After the termination of the transport process, the accredited driver communicates the status of the transport process and of the vehicle through the second client to the server. This information is input through the API and transmitted to the server. If further feedback regarding the transport process is required, for example if articles have been left in the vehicle or if any malfunctioning has occurred in the vehicle, the information is collected by the algorithm on the server and forwarded to the corresponding interface or corresponding client.

The invention is schematically represented in the drawing by means of an embodiment and is explained with reference to the same drawing.

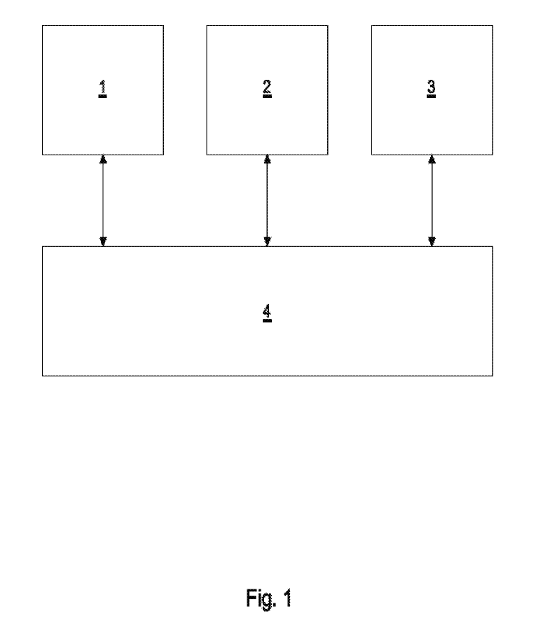

FIG. 1 schematically shows an example of an embodiment of the inventive system.

A first client 1, a second client 2, and a third client 3 are connected to a server 4, exchanging data with the same. The clients (or frontends) 1, 2, 3 are respectively associated to a user group in the system, which input relevant data into the system and receive data from the server (or backend) 4 through their respective client.

Client 1 is associated to the customer of transport processes. They input private or business transport orders through the client 1 and receive corresponding data from the server 4, such as an order confirmation, information regarding the driver, the transport vehicle, the order status, invoice data, etc.

Client 2 is associated to accredited vehicle drivers, which execute the transport processes. They input time intervals through client 2, in which they are available for executing the transport processes and receive from server 4 data regarding the transport orders to be executed and available vehicles. They may confirm or reject the orders through client 2. After performing the transport process, the driver transmits through client 2 data regarding the transport process to server 4, such as the order status, vehicle status, etc. Server 4 transmits data regarding fees of the driver to client 2 after termination of the transport process.

Client 3 is associated to vehicle owners, who provide their vehicles for transport processes. Through client 3, they input the location of vehicle and time intervals, in which the vehicle is available for executing transport processes. The data are transmitted from client 3 to server 4. Server 4 transmits, after completion of transport process, data regarding fees for vehicle owners to client 3.

Server 4 stores data received from clients 1, 2, 3 into a database. The database contains data regarding transport processes, such as time windows for execution, type of transport, persons or materials to be transported, start and destination location, order status, invoice information, etc.; data regarding vehicle drivers, such as data of the individual, such as identification, qualifications, curriculum; time windows of availability, invoice information, etc.: and data regarding the available vehicles, such as identification, data about ownership, status of vehicle, time windows of availability, etc. An algorithm, which is implemented on the server 4 matches the time window for executing a transport order with the time windows of available drivers and available vehicles and assigns a vehicle and driver to the transport order. The algorithm is adapted for determining a complete compatibility of time windows of order, vehicle and driver. Moreover, the algorithm optimizes the workload of available vehicles and drivers. The server 4 sends order data to client 2 and after confirmation of the order by the driver through client 2, it sends data regarding the driver and vehicle to client 1. After execution of the transport process and receipt of corresponding data by client 2, server 4 calculates the bill for the order and transmits data regarding status and invoice to client 1, data regarding fees of the driver to client 2 and data regarding fees of the vehicle owner to client 3.

The invention also refers to a method for controlling transport processes by the inventive system. The method comprises the following steps:

a1) acquiring data of a transport process to be executed by means of a first client, wherein the data comprise at least an identification of the transport process, the type of transport process, the start and destination points of the transport process and the time interval, in which the transport process has to be executed;

a2) forwarding the data about the transport process to be executed to a server;

b1) acquiring data of an available driver by means of a second client, wherein the data comprise at least an identification of the driver and at least a time interval, in which the driver is available for a transport process;

b2) forwarding the data about the available driver to a server;

c1) acquiring data about an available vehicle by means of a third client, wherein the data comprise at least an identification of the vehicle, the location of the vehicle and at least one time interval, in which the vehicle is available for a transport process;

c2) forwarding data about the available vehicle to a server;

d1) receiving data about transport processes to be executed, available vehicles and available drivers by a server;

d2) storing the received data into a database;

d3) executing an algorithm on the server for executing a compatibility check of data of the transport process to be executed, of the driver and vehicle to each other, in particular for determining matches between the time intervals stored in the database for vehicle availability, driver availability and transport processes to be executed;

d4) automatic assignment of an available vehicle and of an available driver to a transport process to be executed based on the determined matching of time intervals of availability of vehicle and of driver with the time interval, in which the transport process has to be executed,

d5) transmission of data regarding the transport process to be executed from the server to the second client;

e) transmission of a confirmation of the transport process to be executed by the second client to the server;

f) transmission of a confirmation of the transport process to be executed as well as data of the assigned vehicle and driver from the server to the first client.

The data of the transport process acquired at step a1) are input by the customer and comprise at least an identification of the transport process, the type of transport process, the start and destination points of the transport process and a time interval, in which the transport process has to be performed. The customer can be a private person, who requires a transport, such as in the case that no public transport means are available, there is no intention to drive, no vehicle is owned, etc. The customer may also be a business person or company, on behalf of which persons or goods have to be transported from one site to another. Examples of typical occasions for private transport orders are a visit at the physician, visiting friends, children pickup from sport, etc. An example of a typical commercial transport order is the transport of articles from A to B. Possible providers of transport orders may be senior residences, health insurances, social services, physicians or universities.

At step b1), data regarding an available vehicle driver are acquired, which comprise at least an identification of the driver and at least a time interval, in which the driver is available for the transport process. As said, preferably accredited drivers are used. A group of potential drivers are people, who want to achieve an additional income during their free time by executing transport processes. Moreover, the system also provides companies with employed drivers the possibility to optimize their workload. The recruiting of accredited drivers may for example be also performed through universities or hiring agencies or head hunters.

At step c1) the owner of the vehicle inputs time interval, in which their vehicle is available for transport processes, such as holidays, business trips, etc. The relevant locations may in particular be large company parking lots as well as parking lots or parking garages at airports or railway stations, since a large number of transport processes is to be expected in these locations. Besides private persons who want to earn money with their vehicles, when they are not using them for themselves, companies may also optimize the loads on their fleet, by providing their vehicles. Car dealers, repair shops, leasing companies, etc., may also be considered as potential users.

In an embodiment of the method, the data of the driver transmitted at step f) comprise a short resume of the driver.

In an embodiment, the method comprises the following additional steps after executing the transport process:

g) transmission of data about the executed transport process from the second client to the server, wherein the data comprise at least a status of the transport process and of the vehicle;

h) transmission of data from the server to the first client, wherein the data comprise at least the status of the transport process.

In an embodiment, the method additionally comprises the transmission of data from the server to the third client, wherein the data comprise at least the status of the vehicle.

In a further embodiment of the method, the server, after completion of step g), generates an invoice for the executed transport process. The invoice then becomes a part of data transmitted at step h) from the server to the first client.

In a further embodiment, the server, after completion of step g) calculates a fee for the owner of the vehicle used for the transport process. The calculated fee then becomes part of data transmitted at step i) from the server to the third client.

In a further embodiment, the server, after completion of step g), calculates a fee for the driver, who has executed the transport process. Subsequently data are sent from the server to the second client, which comprise the calculated fee.

For invoicing, various models are possible. For example, besides the invoicing of the individual transport process, for example according to distance, time, number of transported persons, quantity of transported goods, type of transport vehicle or similar, a forfeit model may also be considered, such as by imposing a fixed monthly charge. In a variant, the operator of the system receives a usage fee from the customer, the drivers and/or the vehicle owners, for example as a mediation fee or a provision for executed transport orders or in the form of a participation to revenue.

1-11. (canceled)

12. A system for controlling transport processes, comprising:
a server configured to:
receive first data of a transport process from a first client, wherein the first data of the transport process comprises at least an identification of the transport process, a type of transport process, a starting point and a destination point of the transport process, and a first time interval during which the transport process is to be performed;
receive second data of a vehicle driver from a second client, wherein the second data of the vehicle driver comprises at least comprises at least an identification of the vehicle driver and at least a second time interval during which the vehicle driver is available for the transport process;
receive third data of a vehicle from a third client, wherein the third data of the vehicle comprises at least an identification of the vehicle, a location of the vehicle and at least a third time interval in which the vehicle is available for the transport process;
store the received first data, the received second data, and the received third data;
process and verify compatibility of the first data of the transport process, the second data of the vehicle driver, and the third data of the vehicle by determining a matching time interval between:
the first time interval during which the transport process is to be performed,
the second time interval during which the vehicle driver is available for the transport process, and
the third time interval in which the vehicle is available for the transport process;
upon determining the matching time interval, automatically associate the vehicle and the vehicle driver to the transport process to be performed;
send the matching time interval, fourth data about the vehicle and fifth data about the vehicle driver to the first client;
send the matching time interval, the type of transport process, the starting point and the destination point of the transport process, and the fourth data about the vehicle and the location of the vehicle to the second client; and
send the fourth data about the vehicle and the fifth data about the vehicle driver to the third client.

13. The system of claim 12, wherein the server is further configured to:
receive a confirmation or a rejection of the transport process from the second client following the send the matching time interval, the type of transport process, the starting point and the destination point of the transport process, and the vehicle and the location of the vehicle to the second client.

14. The system of claim 12, wherein the server is further configured to:
receive, following performance of the transport process, sixth data regarding the performance of the transport process from the second client.

15. The system of claim 14, wherein the server is further configured to:
send, following performance of the transport process, at least a portion of the sixth data regarding the performance of the transport process to the third client.

16. The system of claim 14, wherein the server is further configured to:
send, following performance of the transport process, at least a portion of the sixth data regarding the performance of the transport process to the first client.

17. The system of claim 12, wherein the server is further configured to receive the first data, the second data, or the third data where the respective first client, the respective second client or the respective third client is a mobile application or website.

18. A method for controlling transport, comprising:
receiving first data of a transport process from a first client, wherein the first data of the transport process comprises at least an identification of the transport process, a type of transport process, a starting point and a destination point of the transport process, and a first time interval during which the transport process is to be performed;
receiving second data of a vehicle driver from a second client, wherein the second data of the vehicle driver comprises at least comprises at least an identification of the vehicle driver and at least a second time interval during which the vehicle driver is available for the transport process;
receiving third data of a vehicle from a third client, wherein the third data of the vehicle comprises at least an identification of the vehicle, a location of the vehicle and at least a third time interval in which the vehicle is available for the transport process;
storing the received first data, the received second data, and the received third data;
processing and verifying compatibility of the first data of the transport process, the second data of the vehicle driver, and the third data of the vehicle by determining a matching time interval between:
the first time interval during which the transport process is to be performed,
the second time interval during which the vehicle driver is available for the transport process, and
the third time interval in which the vehicle is available for the transport process;
upon determining the matching time interval, automatically associating the vehicle and the vehicle driver to the transport process to be performed;
sending the matching time interval, fourth data about the vehicle and fifth data about the vehicle driver to the first client;
sending the matching time interval, the type of transport process, the starting point and the destination point of the transport process, and the fourth data about the vehicle and the location of the vehicle to the second client; and
sending the fourth data about the vehicle and the fifth data about the vehicle driver to the third client.

19. The method of claim 18, further comprising:
subsequent to performance of the transport process, receiving sixth data regarding the performance of the transport process from the second client, wherein the fourth data comprises at least a status of the transport process and a status of the vehicle; and
transmit the status of the transport process to the first client.

20. The method of claim 19, further comprising:
transmit the status of the vehicle to the third client.

21. The method of claim 19, wherein the server is further configured to:
subsequent to the performance of the transport process, generate an invoice for the transport process, and transmit the invoice of the transport process to the first client.

22. The method of claim 20, wherein the server is further configured to:
subsequent to the performance of the transport process, calculate a first fee for an owner of the vehicle for the transport process, and transmit the first fee to the third client.

23. The method of claim 21, wherein the server is further configured to:
subsequent to the performance of the transport process, calculate a second fee for the driver for the transport process, and transmit the second fee to the second client.
